(19) United States
(12) Patent Application Publication
(10) Pub. No.: US 2011/0204682 A1
(43) Pub. Date: Aug. 25, 2011

(54) VEHICLE ROOF STRUCTURE

(75) Inventors: Masayuki Kamei, Aichi-Ken (JP); Yusuke Yoshita, Aichi-ken (JP); Yukio Matsuda, Aichi-ken (JP); Hideaki Terai, Aichi-ken (JP); Hirotaka Inaba, Aichi-ken (JP)

(73) Assignees: TOYOTA SHATAI KABUSHIKI KAISHA, Aichi (JP); KABUSHIKI KAISHA TOYOTA JIDOSHOKKI, Aichi (JP)

(21) Appl. No.: 13/061,060

(22) PCT Filed: Jun. 23, 2009
(86) PCT No.: PCT/JP2009/061380

§ 371 Date: May 10, 2011

(30) Foreign Application Priority Data
Aug. 29, 2008 (JP) 2008-221352

(51) Int. Cl. B60J 10/12; B23P 11/00

(52) U.S. Cl. 296/216.04; 29/897.2

(57) ABSTRACT

A sun shade device is positioned on an inner surface of a panorama roof panel. The sun shade device includes a sheet-shaped shade member that can be pulled out and retracted in back and forth directions of a vehicle, and a shade cover member that can cover the wound shade member. The shade cover member is made of an elongated rigid body and is laterally bridged in right and left directions of the vehicle along a winding axis of the shade member. The shade cover member is secured to a vehicle main body at both ends thereof.

### PRIORITY CLAIM

The present application is a National Phase entry of PCT Application No. PCT/JP2009/061380, filed Jun. 23, 2009, which claims priority from Japanese Patent Application Number 2008-221352, filed Aug. 29, 2008, the disclosures of which are hereby incorporated by reference herein in their entirety.

### TECHNICAL FIELD

The present invention relates to a vehicle roof structure. More particularly, the present invention relates to a daylighting vehicle roof structure having a roof opening covered with a panorama roof panel that is made of an unframed transparent plate.

### BACKGROUND ART

Conventionally, in a daylighting vehicle roof structure, a framed transparent plate, e.g., a framed glass, is fitted in a roof opening. In general, in the vehicle roof structure thus constructed, reinforcement portions are integrally provided to inside of a frame along right and left directions thereof, so that a side impact load given by a side collision can be transmitted therealong. Thus, a vehicle body may have an increased rigidity.

Conventionally, in another daylighting vehicle roof structure, an unframed transparent plate is disposed on a periphery of a roof opening in terms of weight reduction or other such purposes. Even in the vehicle roof structure thus constructed, reinforcement members are provided, so that a load generated when an impact is laterally applied can be transmitted therealong. For example, Japanese Laid-Open Patent Publication No. 2007-131208 described below discloses a vehicle roof structure in which an opening formed in a roof panel is covered by an unframed permeable panel (sunroof panel) made of glass or synthetic resin, so as to permit daylighting. In the vehicle roof structure described in Japanese Laid-Open Patent Publication No. 2007-131208, the sunroof panel is formed as an unframed panel. However, roof reinforcement members each having a hat-shape in cross section are positioned in front and rear portions of the opening of the roof panel and are bridged between right and left roof side rails, so that the load caused by the laterally applied impact can be transmitted therealong. As a result, a vehicle body may have an increased rigidity. Further, the vehicle roof structure described in Japanese Laid-Open Patent Publication No. 2007-131208 has a sunshade device that can shield the sun by pulling out a retractable shade member made of a sun shield fabric. The sunshade device is formed as a module in which component members such as the shade member, a retractor and the like are attached to an upper surface of a guide member constructed of a permeable synthetic resin panel. In addition, the modularized sunshade device is threadably connected to a flange portion and the roof reinforcement members positioned around the opening of the sunroof panel via attaching holes that are formed in a circumference of the guide member, so as to be disposed on a vehicle interior side of the sunroof panel.

Further, Japanese Laid-Open Patent Publication No. 2003-39955 discloses a vehicle roof structure having a movable panel that is made of an unframed transparent plate and is capable being opened and closed, and in which rigidity thereof against a side impact load is increased. In the vehicle roof structure described in Japanese Laid-Open Patent Publication No. 2003-39955, a frame member that is elongated in right and left directions is fixedly connected to a vehicle interior side surface of the movable panel. The frame member is can move back and forth integrally with the movable panel. While the frame member can move integrally with the movable panel, the frame member can engage roof rails at an open position and a closed position of the movable panel, so that the side impact load can be transmitted therealong.

As described above, it is conventionally known that even when the unframed transparent plate is used, the rigidity against the side impact load can be increased by additionally providing the reinforcement members that are laterally bridged in the right and left directions.

### DISCLOSURE OF THE INVENTION

### Problem to be Solved by the Invention

It is advantageous to use an unframed transparent plate is used in a daylighting vehicle roof structure in terms of vehicle weight reduction. However, in such a case, it is necessary to additionally provide reinforcement members in order to increase rigidity against a side impact load. In addition, a sunshade is provided in consideration of comfort in a vehicle cabin and the like. As a result, it is difficult to perform the weight reduction.

Thus, there is a need in the art to provide an improved vehicle roof structure.

### SUMMARY OF THE INVENTION

According to a first aspect of the present invention, in a daylighting vehicle roof structure, a roof opening is covered by a panorama roof panel that is made of an unframed transparent plate. The roof structure includes a sun shade device that is positioned on an inner surface of the panorama roof panel. The sun shade device includes a sheet-shaped shade member that can be pulled out and retracted in back and forth directions of a vehicle, and a shade cover member that can cover the wound shade member. The shade cover member is made of an elongated rigid body and is laterally bridged in right and left directions of the vehicle along a winding axis of the shade member while suspended from the inner surface of the panorama roof surface via a folder. The shade cover member is secured to a vehicle main body at both ends thereof.

In the vehicle roof structure, the shade cover member constituting the sun shade device is made of the rigid body and is laterally bridged in the right and left directions of the vehicle. Further, the shade cover member is secured to the vehicle main body at both ends thereof. Therefore, the shade cover member can cover the wound shade member. In addition, the shade cover member can transmit a side impact load. Therefore, rigidity against the side impact load can be maintained by the shade cover member. Thus, according to the vehicle roof structure, reinforcement members to transmit the load therealong can be omitted, so that weight reduction can be performed.

In one embodiment, the shade cover member may preferably be positioned in a portion that is overlapped with a center pillar in the back and forth directions of the vehicle.

In this case, because the side impact load applied to the center pillar is efficiently transmitted to the shade cover member, the rigidity against the side impact load can be further increased.

The panorama roof panel may preferably be made of a resin. Further, the shade cover member may preferably be suspended from the inner surface of the panorama roof surface. In this case, because the inside surface of the panorama roof panel can be supported by the shade cover member that is laterally bridged over the vehicle main body, the panorama roof made of the resin can be prevented from being easily flexed.

In this case, it is preferred that the shade cover member is secured to the vehicle main body at both ends via an attachment bracket because the shade cover member can be easily secured to the vehicle main body.

Such a vehicle roof structure can preferably be manufactured in the following manner. That is, the manufacturing method of the vehicle roof structure may include suspending the shade cover member from the inner surface of the panorama roof surface, so as to attach the shade member and the shade cover member to the panorama roof panel, adhesively securing the panorama roof panel to the vehicle main body thereafter, and connecting the attachment brackets to the both ends of the shade cover member from below, so as to connect the shade cover member to the vehicle main body.

According to the manufacturing method, the shade cover member is attached to the panorama roof panel that is not yet adhesively secured to the vehicle main body, so as to be incorporated thereinto. Therefore, it is possible to determine a vertical position of the shade cover member with respect to the panorama roof panel without consideration of flexure of the panorama roof panel that can be produced when it is adhesively secured to the vehicle main body. In addition, the manufacturing method may provide following advantages, for example, when the panorama roof panel is attached to the roof opening that is positioned between the center pillars. That is, in such a case, when the shade cover member should be positioned in the portion that is overlapped with the center pillar in the back and forth directions of the vehicle, the shade cover member is positioned in the middle in back and forth directions of the panorama roof panel. As a result, when the shade cover member is suspended from the inner surface of the panorama roof surface, it is advantageous in that the panorama roof panel can be prevented from being deformed (flexed). Further, two shade members that are respectively constructed to be pulled out forwardly and backwardly may be used. In such a case, in order to suspend the shade cover member from the panorama roof panel such that pulling out and retracting motion of the two shade members cannot be obstructed, the shade cover member must be suspended from the panorama roof panel within a narrow range between the two shade members. Even in such a case, the shade cover member is suspended from the panorama roof panel before the panorama roof paned is adhesively secured to the vehicle main body, so as to be incorporated thereinto. Therefore, it is advantageous in that the shade cover member can be relatively easily combined to the panorama roof panel.

### EFFECTS OF THE INVENTION

According to the present invention, it is possible to maintain rigidity against a side impact load is maintained without increasing a weight. Furthermore, when a shade cover member is disposed on a position that is overlapped with positions of center pillars in back and forth directions of an automobile, the rigidity against the side impact load can be further increased.

### BRIEF DESCRIPTION OF THE DRAWINGS

FIG. 1 is an exploded perspective view of a vehicle roof structure according to an embodiment of the invention.

FIG. 2 is a cross sectional view taken along line II-II of the vehicle roof structure shown in FIG. 1.

FIG. 3 is a perspective view of a bracket portion of the vehicle roof structure shown in FIG. 1.

FIG. 4 is a cross sectional view taken along line IV-IV of the vehicle roof structure shown in FIG. 1.

### BEST MODES FOR CARRYING OUT THE INVENTION

Hereinafter, an embodiment of the present invention will be described with reference to the drawings. Further, in each drawing, arrows Fr, L, R and Up which are shown to help understanding means forward, leftward, rightward and upward.

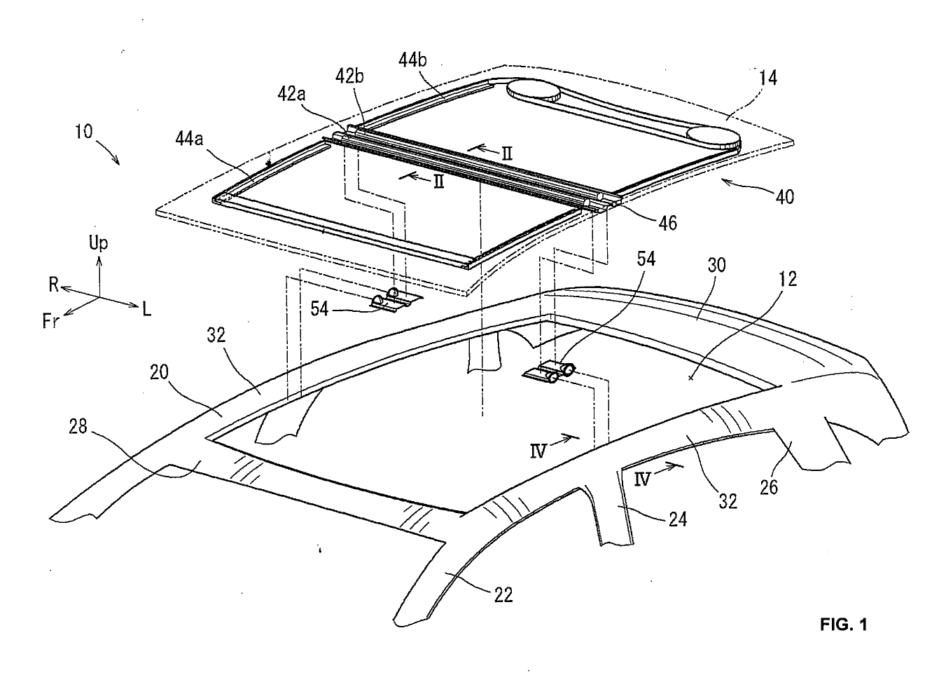

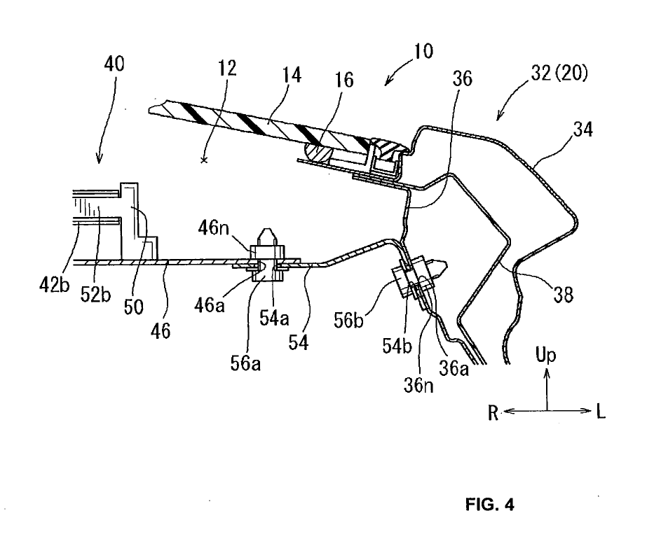

As shown in FIG. 1, a vehicle main body 20 of a vehicle having a vehicle roof structure 10 (which may be hereinafter simply referred to as a roof structure) of the present embodiment includes pillars, i.e., front pillars 22 that are positioned diagonally forwardly relative to front seats (a driver's seat and a passenger seat), center pillars 24 that are positioned between the front seats and rear seats, and rear pillars 26 that are positioned diagonally rearwardly relative to the rear seats. Further, the vehicle main body 20 includes a front header panel 28 that is bridged between the right and left front pillars 22, a rear header panel 30 that is bridged between the right and left rear pillars 26, and roof side rails 32 that is positioned in right and left sides of the vehicle so as extend along back and forth directions thereof. In the roof structure 10, a roof opening 12 is defined by the roof side rails 32 positioned in both side portions, the front header panel 28 positioned in a front portion, and the rear header panel 30 positioned in a rear portion. The roof opening 12 thus defined is covered by a panorama roof panel 14 made of a transparent plate, so as to permit daylighting. The panorama roof panel 14 is a transparent plate made of a resin such as polycarbonate or other such materials, and is formed as an unframed panel. In the roof structure 10 of the present embodiment, the whole roof opening 12 that is positioned between the center pillars 24 is covered by the panorama roof panel 14 that is formed as a single piece. The panorama roof panel 14 is adhesively secured to the vehicle main body 20 by an adhesive 16 while a peripheral edge thereof is disposed on a peripheral edge of the roof opening 12 (FIG. 4).

As shown in FIG. 1, the panorama roof panel 14 includes a sun shade device 40 that is positioned on an inner surface (a lower surface) thereof. The sun shade device 40 includes sheet-shaped sun shieldable shade members that can be pulled out and retracted, so that the sun can be shielded by pulling out the shade members along the inner surface of the panorama roof panel 14. The sun shade device 40 includes two shade members, i.e., a shade member 42a that can cover a substantially front half of the panorama roof panel 14, and a shade member 42b that can cover a substantially rear half of the panorama roof panel 14. Each of the shade members 42a and 42b is wound up in a substantially central portion in back and forth directions of the panorama roof panel 14. The shade member 42a is constructed to be pulled out forwardly along guide rails 44a, so as to cover a front side of the panorama roof panel 14. Conversely, the shade member 42b is constructed to be pulled out backwardly along guide rails 44b, so as to cover a rear side of he panorama roof panel 14. Further, because a moving mechanism for pulling out and winding up each of the shade members 42a and 42b of the sun shade device 40 has the same construction as the conventional mechanism, a detailed description of the mechanism may be omitted.

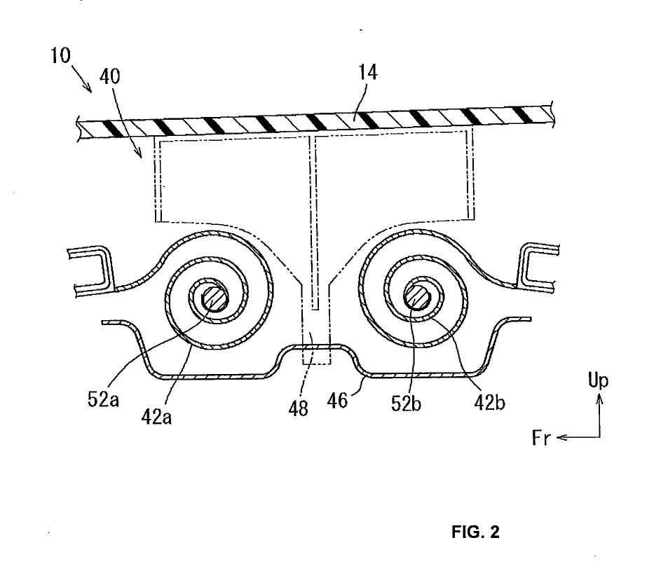

The sun shade device 40 includes a shade cover member 46 that is capable of covering the shade members 42a and 42b that are wound up. The shade cover member 46 is formed as an elongated member and is bridged in right and left directions of the vehicle main body 20. The shade cover member 46 is formed by hot pressing a steel sheet having a thickness of 2.3 mm. The shade cover member 46 has combined two inverted hat-shapes in cross section in transverse directions thereof. The two hat shaped portions of the shade cover member 46 are respectively capable of covering bottom portions of the shade members 42a and 42b that are wound up (FIG. 2). The shade cover member 46 is secured to the vehicle main body 20 at both ends, so as to have a function of transmitting a side impact load, which will be hereinafter described in detail. The shade cover member 46 is suspended from the inner surface of the panorama roof surface 14 via a folder 48, and has a pair of bearing brackets 50 that are vertically provided thereon at right and left portions thereof (FIG. 4). Winding axes 52a and 52b of the shade members 42a and 42b are supported by the bearing brackets 50.

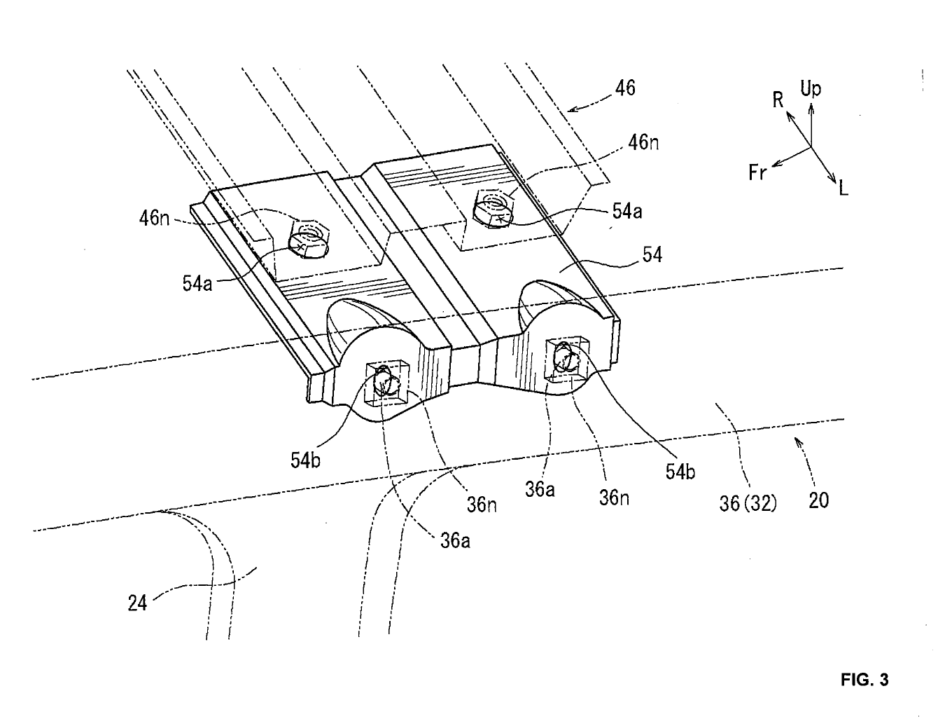

As shown in, for example, FIG. 3, the shade cover member 46 constituting the sun shade device 40 is positioned in a portion that is overlapped with the center pillars 24 in the back and forth directions of the vehicle and is secured to the roof side rails 32 at both ends via attachment brackets 54. Each of the attachment brackets 54 is made of a steel sheet. Each of the attachment brackets 54 has a recess extending in the right and left directions of the vehicle in order to increase rigidity thereof. Each of the attachment brackets 54 has through holes 54a that are formed in one end portion in right and left directions thereof, so as to be coupled to the shade cover member 46 therethrough. Each of the attachment brackets 54 is bent at the other end portion thereof and has through holes 54b that are formed in a bent portion, so as to be coupled to each of the roof side rails 32. As shown in FIG. 4, the shade cover member 46 has through holes 46a that are formed in each end portion thereof. Further, nuts 46n are welded to an upper surface of the shade cover member 46 so as to be aligned with the through holes 46a. Further, bolts 56a are inserted into the through holes 54a formed in one end of each of the attachment brackets 54 and the through holes 46a formed in each end portion of the shade cover member 46 and are screwed into the nuts 46n, so that the shade cover member 46 and the attachment brackets 54 are coupled to each other. Each of the roof side rails 32 is constructed of an outer panel 34, an inner panel 36 and a reinforcement 38 to form a closed cross-sectional structure. The inner panel 36 has through holes 36a that are formed therein. Further, nuts 36n are welded to a vehicle exterior side surface (a left L surface in FIG. 3) of the inner panel 36. Further, bolts 56b are inserted into the through holes 54b formed in the other end portion of each of the attachment brackets 54 and the through holes 36a formed in the inner panel 36 and are screwed into the nuts 36n, so that each of the attachment brackets 54 and the inner panel 36 are coupled to each other. Thus, both ends of the shade cover member 46 are secured to the right and left roof side rails 32 via the attachment brackets 54, so that the shade cover member 46 can be bridged over the vehicle main body 20.

A preferable manufacturing method of the vehicle roof structure 10 will be described. First, as shown in FIG. 1, the shade cover member 46 having the shade members 42a and 42b is connected to the inner surface of the panorama roof panel 14 via the folder 48 (FIG. 2), so as to be suspended therefrom. Thus, the sun shade device 40 can be incorporated into the panorama roof panel 14. Thereafter, the roof opening 12 is covered by the panorama roof panel 14 having the sun shade device 40. The panorama roof panel 14 is then disposed on the peripheral edge of the roof opening 12 and is adhesively secured thereto by an adhesive 16. Further, the both ends of the shade cover member 46 are secured to the roof side rails 32 via the attachment brackets 54. Thus, the vehicle roof structure 10 can be manufactured.

According to the vehicle roof structure 10 thus constructed, following effects can be obtained.

First, the shade cover member 46 constituting the sun shade device 40 can simply cover the wound shade members 42a and 42b. In addition, because the both ends of the shade cover member 46 are secured to the roof side rails 32, the shade cover member 46 can function to transmit the side impact load. Therefore, rigidity against the side impact load can be maintained. In addition, the number of parts can be reduced, so that weight reduction can be performed.

Further, in the roof structure 10, the shade cover member 46 is positioned in the portion that is overlapped with the center pillars 24 in the back and forth directions of the vehicle. Therefore, the rigidity against the side impact load can be further increased.

Further, the present invention is not limited to the embodiment described above, and the embodiment can be easily changed or modified without departing from the gist of the present invention.

For example, in the roof structure, the roof opening can be arranged so as to not be positioned between the pillars. For example, the roof opening can be formed so as to only be positioned in a front side of the center pillars 24. In such a case, a single shade member may preferably be used and constructed to be wound up in a rear side of the roof opening. Further, the shade cover member may preferably be positioned in the portion that is overlapped with the center pillars 24.

1. A daylighting vehicle roof structure in which a roof opening is covered by a panorama roof panel that is made of an unframed transparent plate, comprising:
a sun shade device that is positioned on an inner surface of the panorama roof panel,
wherein the sun shade device includes a sheet-shaped shade member that can be pulled out and retracted in back and forth directions of a vehicle, and a shade cover member that can cover the wound shade member, wherein the shade cover member is made of an elongated rigid body and is laterally bridged in right and left directions of the vehicle along a winding axis of the shade member while suspended from the inner surface of the panorama roof surface via a folder, and wherein the shade cover member is secured to a vehicle main body at both ends thereof.

2. The vehicle roof structure as defined in claim 1, wherein the shade cover member is positioned in a portion that is overlapped with a center pillar in the back and forth directions of the vehicle.

3. (canceled)

4. The vehicle roof structure as defined in claim 1, wherein the shade cover member is secured to the vehicle main body at both ends via an attachment bracket.

5. A manufacturing method of the vehicle roof structure defined in claim 4, comprising:
suspending the shade cover member from the inner surface of the panorama roof surface, so as to attach the shade member and the shade cover member to the panorama roof panel,
adhesively securing the panorama roof panel to the vehicle main body thereafter, and
connecting the attachment brackets to the both ends of the shade cover member from below, so as to connect the shade cover member to the vehicle main body.
